(19) United States
(12) Patent Application Publication
(10) Pub. No.: US 2025/0289119 A1
(43) Pub. Date: Sep. 18, 2025

(54) METHOD AND SYSTEM FOR PROGRAMMING AN INDUSTRIAL ROBOT

(71) Applicant: ABB SCHWEIZ AG, Baden (CH)

(72) Inventors: Ye Tian, Shanghai (CN); Jiafan ZHANG, Shanghai (CN)

(21) Appl. No.: 19/222,667

(22) Filed: May 29, 2025

Related U.S. Application Data
(63) Continuation of application No. PCT/CN2022/135720, filed on Nov. 30, 2022.

(51) Int. Cl. B25J 9/00; B25J 9/16

(52) U.S. Cl. CPC B25J 9/0081; B25J 9/1664

(57) ABSTRACT

A method includes acquiring a first set of reachable posture data of a tool model by moving the tool model around a first portion of a workpiece in a reachable area of the robot, the tool model being held and moved by a user without being held by the robot; in response to the first portion of the workpiece being processed by the tool model, causing the tool model to emit a control signal to move the workpiece such that a second portion of the workpiece is within the reachable area of the robot; acquiring a second set of reachable posture data by moving the tool model around the second portion of the workpiece; and generating, at least based on the first set of reachable posture data, the control signal and the second set of reachable posture data, a first and a second executable code.

### FIELD

Embodiments of the present disclosure generally relate to an industrial robot, and a method and a system for programming the industrial robot.

### BACKGROUND

Industrial robots are widely used in industries. The industrial robots typically comprise a robotic arm having a plural of joints and a controller programmed to control actions of the robotic arm. Because of the complexity of robot programming, it is difficult for small and medium sized enterprises to invest in robotics. It is curial to develop a programming method which facilitates for craftsmen to transfer their skills to programs for industrial robots.

Program by demonstration (PbD) is an end-user development technique for teaching a robot by demonstrating the task to transfer directly instead of programming it through machine commands.

However, in some cases, the demonstrated pose (position and orientation) is unreachable for a robot, hence an external axis is added to rotate or offset the object.

However, there is no mature method to do the PbD with an external axis.

### SUMMARY

Example embodiments of the present disclosure provide a method and a system for programming the industrial robot which can simplify robotics programming.

In a first aspect of the present disclosure, it is provided a method for programing an industrial robot, comprising: acquiring a first set of reachable posture data of a tool model by moving the tool model around a first portion of a workpiece in a reachable area of the robot, the tool model being held and moved by a user without being held by the robot; in response to that the first portion of the workpiece has been processed by the tool model, causing the tool model to emit a control signal to move the workpiece such that a second portion of the workpiece is within the reachable area of the robot; acquiring a second set of reachable posture data of the tool model by moving the tool model around the second portion of the workpiece; and generating, at least based on the first set of reachable posture data, the control signal and the second set of reachable posture data, a first executable code which is to be executed by the robot to process the workpiece via a real tool held by the robot, and a second executable code which is to be executed to move the workpiece when the robot processes the workpiece via the real tool. According to the present disclosure, the workpiece, in particularly the external axis thereof, rotates or moves while demonstrating by the tool model, the data from external axis and the demonstration data (i.e. the reachable posture code) are recorded and synchronized in time domain. These data are then programmed into machine code sent to robot controller. Executable codes from controller may be used to control robot and external axis simultaneously. The method for programing for the robot is thus of high efficiency, of high scalability and of easy operability.

In some embodiments, acquiring each of the first and second sets of the reachable posture data of the tool model comprises: receiving posture data of the tool model from a posture tracker configured to capture the posture data; acquiring a transfer matrix between a tool model coordinate system and a robot coordinate system; converting the posture data from the tool model coordinate system to the robot coordinate system by the transfer matrix; determining reachability of the posture data by the robot; and acquiring the reachable posture data based on the reachability of the posture data. As such, the posture data captured by the posture tracker may be used for mathematical calculation in conjunction with the robot. By determining reachability of the posture data by the robot, the user's movement may be guided to avoid the user's movement beyond the reach for the robot.

In some embodiment, the method further comprises acquiring a movement data of the workpiece associated with the control signal, wherein generating the first executable code and the second executable code comprises: based on the first set of reachable posture data, the movement data, and the second set of reachable posture data, generating the first executable code and the second executable code. By feeding back the actual movement information of the axis, the generated executable code may be of higher accuracy.

In some embodiments, the control single is aligned with an end point of the first set of reachable posture data and a start point of the second set of reachable posture data in time domain. By align the control signal with the first set of reachable posture data and a start point of the second set of reachable posture data in time domain, there data from the external axis O and the demonstration date may be synchronized.

In some embodiments, the posture data comprises spatial position data and orientation data about each point on a moving path of the tool model; and the movement of the workpiece comprises at least one of a translation of the workpiece and a rotation of the workpiece around an axis. In this way, the external axis may be moved in many ways, and a plenty of postures of the external axis may be achieved.

In some embodiment, during movement of the tool model, sending an alarm instruction in real time once it is determined that the posture data is approaching boundary of the reachable area of the robot. In this way, once the posture data cannot be reached by the robot, the user is warned. The user may be well guided so as to control the posture of the tool model properly, so as to get the reachable posture data in high accuracy.

In a second aspect of the present disclosure, it is provided a method for programing an industrial robot, comprising: acquiring a posture data of a tool model and a three-dimensional model of a workpiece to be processed simultaneously, by moving tool model provided with at least one three-dimensional sensor therein around the workpiece, wherein the tool model is held and moved by a user without being held by the robot, and the workpiece keeps stationary, and the at least one three-dimensional sensor is configured to acquire the three-dimensional model of the workpiece; and generating, at least based on the posture data and the three-dimensional model, a first executable code which is to be executed by the robot to process the workpiece via a real tool held by the robot, and a second executable code which is to be executed to move the workpiece. In this method, the posture data (or a trajectory) and the scanning data (3D model) are recorded synchronously, and are naturally aligned. Therefore, no CAD model is needed anymore for automatic motion plan and code generation while teaching with the PbD. Further, there is no need for any effort to align the path and the 3D model, thereby causing the process high efficiency and time-saving.

In some embodiment, generating the first executable code and the second executable code comprises: segmenting the posture data into a plurality of segments, based on a robot workspace of the robot and a position relationship between the robot and the workpiece, generating a working path and a movement of the workpiece for each of the plurality of segments, and programing the first executable code based on the working path for each of the plurality of segments and the second executable code based on the movement of the workpiece for each of the plurality of segments. In this embodiment, for each posture of the workpiece, a new path may be determined, and then the executable for the robot and the workpiece may be generated.

In some embodiment, acquiring the posture data of the tool model comprises: receiving the posture data of the tool model from a posture tracker configured to capture the posture data; acquiring a transfer matrix between a tool model coordinate system and a robot coordinate system; and converting the posture data from the tool model coordinate system to the robot coordinate system by the transfer matrix.

In some embodiment, the at least one three-dimensional sensor is calibrated with respect to the tool model; and the posture data of the tool model and the three-dimensional model of the workpiece are aligned with each other in spatial domain. In this method, by calibrating the three-dimensional sensor with respect to the tool model in advance, when demonstrating or teaching, the acquired posture data of the tool model and the acquired three-dimensional model of the workpiece are aligned with each other in spatial domain.

In a third aspect of the present disclosure, it is provided a for programming an industrial robot, comprising: a tool model configured to move around a workpiece to be processed; a posture tracker configured to capture posture data of a tool model moved by a user around the workpiece; and a processor configured to perform the method according to the first aspect.

In a fourth aspect of the present disclosure, it is provided a system for programming an industrial robot, comprising: a tool model configured to move around a workpiece to be processed; a posture tracker configured to capture posture data of a tool model moved by a user around the workpiece; and a processor configured to perform the method according to the second aspect.

In a fifth aspect of the present disclosure, it is provided a computer program product being tangibly stored on a computer readable storage medium and comprising instructions which, when executed on at least one processor, cause the at least one processor to perform the method according to the first aspect.

In a sixth aspect of the present disclosure, there is provided a computer program product being tangibly stored on a computer readable storage medium and comprising instructions which, when executed on at least one processor, cause the at least one processor to perform the method according to the second aspect.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 is a schematic view showing operation of an industrial robot to be programmed;

FIG. 2 is a schematic view showing a system for programming the industrial robot of FIG. 1 according to one example embodiment of the present disclosure;

FIG. 3 illustrates a flowchart of a method for programming an industrial robot according to one example embodiment of the present disclosure;

FIG. 4 is a block view of the system for programming an industrial robot according to one example embodiment of the present disclosure;

FIG. 5 illustrates a flowchart of a method for programming an industrial robot according to one example embodiment of the present disclosure; and

FIG. 6 is a block view of the system for programming an industrial robot according to one example embodiment of the present disclosure

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state that may be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

Unless specified or limited otherwise, the terms “mounted,” “connected,” “supported,” and “coupled” and variations thereof are used broadly and encompass direct and indirect mountings, connections, supports, and couplings. Furthermore, “connected” and “coupled” are not restricted to physical or mechanical connections or couplings. In the description below, like reference numerals and labels are used to describe the same, similar or corresponding parts in the Figures. Other definitions, explicit and implicit, may be included below.

Lead-through programming method for the robot indeed improves the programming efficiency. However, as mentioned above, this method is not usable in many application scenarios. For example, the industrial robots are inaccessible for the user in the industrial field, for example, due to safety reasons and robots collision. Further, the workpiece to be process may have a portion, which is out of workspace of the robot and cannot be processed by the robot.

Thus, it is proposes a Program by demonstration (PbD), which is an end-user development technique for teaching a robot by demonstrating the task to transfer directly instead of programming it through machine commands. However, in some cases, the demonstrated pose (position and orientation) is unreachable for a robot, hence an external axis is added to rotate or offset the object. However, there is no mature method to do the PbD with an external axis.

The present disclosure proposes two novel methods which make the demonstrated path executable for robot and the workpiece with an external axis without any additional manual edit, thereby improving the efficiency of PbD and user experience greatly. Through the following detailed descriptions with reference to the accompanying drawings, the above features and advantages of the example embodiments disclosed herein will become more comprehensible.

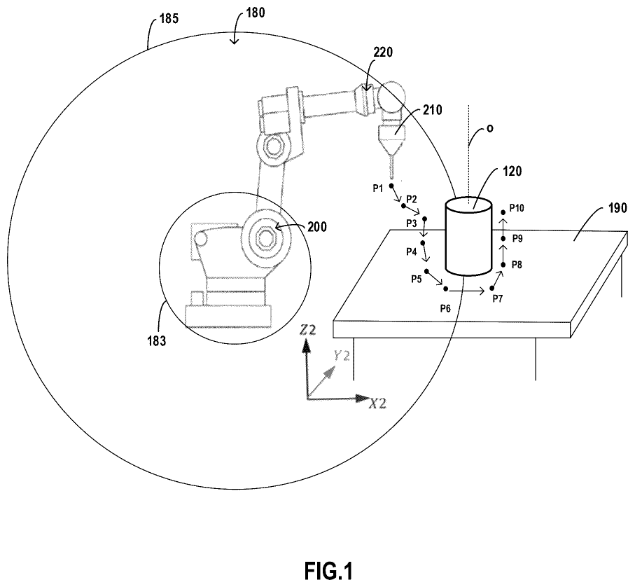

FIG. 1 shows an industrial robot 200 to be programmed and the industrial robot 200 may be arranged in an industrial field to process one or more workpiece 120. As shown in FIG. 1, the robot 200 comprises a robotic arm 220 and a real tool 210 attached to the robotic arm 220. The workpiece 120 may be placed on a worktable 190. The workpiece 120 can rotate around an external axis O whenever the user wants to. However, in some cases, the workpiece 120 can only rotate around the external axis O during the actual work, which means the robot 200 processes the workpiece with the real tool 210, and cannot rotate around the axis O when teaching the robot 200 by the PbD device or tool model 110. The person skilled in the art should be understood that the movement of the axis O may be other type of movement, such as translation, and the orientation of the axis O may be any direction rather than the direction perpendicular to the worktable as shown in FIG. 1.

Due to the structural limits, the robotic arm 220 can move within a limited area. A workspace 180 is shown as an example. The workspace 180 refers to an area that may be surely reached by the robotic arm 220. When the tool is within this workspace 180, the posture of the tool may be reached. The workspace 180 may be determined in advance before programming in accordance with the structural characteristics of the robot. The workspace 180 may be of any proper shapes. In the shown example, the workspace 180 is in a shape of a ring and comprises an inner boundary 183 and an outer boundary 185. It should be understood that the shape of the workspace 180 is merely illustrative and the shape of the workspace 180 may be of any other proper shapes.

The robot 200 is configured to execute codes in a controller of the robot 200 to control movements of the robotic arm 220 along a programmed path so that the tool 210 can processes the workpieces automatically. For processing a first portion of the workpiece 120, the tool 210 should take a posture adapted to process the workpieces as required and follow a path, for example, as indicated by the arrows P1 to P6. Likewise, for processing a second portion of the workpiece 120, the tool should take a posture and follow the path, for example, as indicated by the arrows P7 to P10. It is to be understood that the workpiece 120 is shown merely for sake of illustration. The path as indicated by the arrows P7 to P10 is actually beyond reachability of the robot 200.

It should be understood that the path from arrows P1-P10 is merely illustrative and the shape of the path may be of any other proper shapes. Further, it should be understood that the shape of the workpiece 120 is merely illustrative. The number of the portions included in the workpiece 120 can be other number. Further, at a certain posture of the workpiece 120, the first portion in the reachable area of the robot may comprise a set of sub-portions, and the second portion not in the reachable area of the robot may comprise a set of sub-portions. The processing for the first or second portion can be done sub-portion by sub-portion.

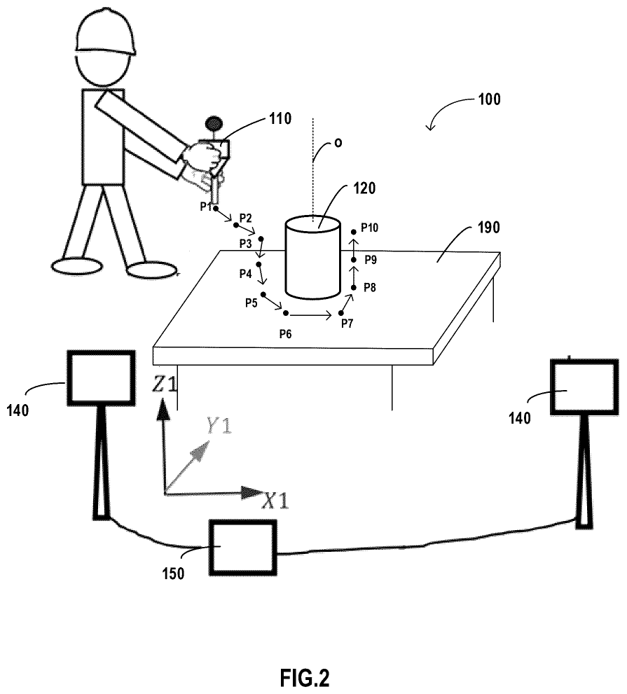

FIG. 2 shows a system 100 for programming the industrial robot 200 according to one example embodiment of the present disclosure. As shown in FIG. 2, the system 10 for programming the industrial robot 200 comprises a tool model 110, a posture tracker 140 configured to capture posture data of the tool model 110, and a processor 150 configured to covert the posture data to processor-executable codes.

In the system of the present disclosure, completely different from the lead through programming method, the tool model 110 is not attached to a robotic arm 220 of the industrial robot 200 but is directly moved by a user, for example a skilled worker. The tool model 110 may be of various forms. In some example, the tool model 110 may be real tool for processing the workpiece. In some example, the tool model may just be a model for programming and may be of any proper shapes. During the programming process, the user can grip the tool model 110 and move the tool model 110 around a workpiece to be processed 120 along a path which is proper for processing the workpiece. The path is generally determined by the skilled worker. In the shown example, the tool is directly moved by the user. In some example, the tool may be moved by a gripper carried by the user. The tool model may be of various types according to the processing types of the workpiece.

As shown in FIG. 2, there is a workpiece 120 to be processed on the worktable 190. A user is carrying a tool model 110. The user moves the tool model 110 around the workpiece 120 to be processed on the worktable 190. During the movement of the tool model 110, the posture tracker 140 captures the posture data of the tool model 110. The processor 150 converts the captured posture data to machine executable codes.

The posture tracker 140 is configured to capture posture data of the tool model 110 moved by the user. Typically, the posture data may comprise position data.

The position data indicate the position of the tool in the robotic system. With the position data, the path followed by the tool may be formed. In some examples, the posture data may comprise orientation data. The orientation data indicate the orientation of the tool. The posture tracker 140 may take various forms as long as the posture tracker 140 can track or acquire the posture data of the tool model 110. In the shown example, one or two trackers 140 are arranged at a proper position of the worktable 190 for capturing posture data of the tool model 110 when being moved by the use, for example, at a side of the worktable 190. In some embodiments, the track station 140 alone can capture posture data of the tool model 110. Alternatively or in addition, a position sensor or a detectable marker may be provided on/in the tool model 110. In this way, the posture data may be more accurately acquired. It is to be understood that this tracking arrangement is merely illustrative. In some other embodiments, for example, the track station XX may be arranged on the tool model 110 and various tracking methods may be used to determine the posture data of the tool model 110 moved by the user.

The processor 150 is connected to the posture tracker 140. The posture data captured by the posture tracker 140 may be sent to the processor 150 in real time. The processor 150 is configured to convert the posture data of the tool model 110 into computer-executable codes which may be loaded into the controller of the industrial robot 200. When the controller of the industrial robot 200 loaded by the computer-executable instructions, the robot 200 can automatically process the workpiece by execution of the programmed codes.

In the present disclosure, the processor 150 is configured to analyze the acquired posture data from the posture tracker 140 and to determine reachability of the posture data by the robot 200.

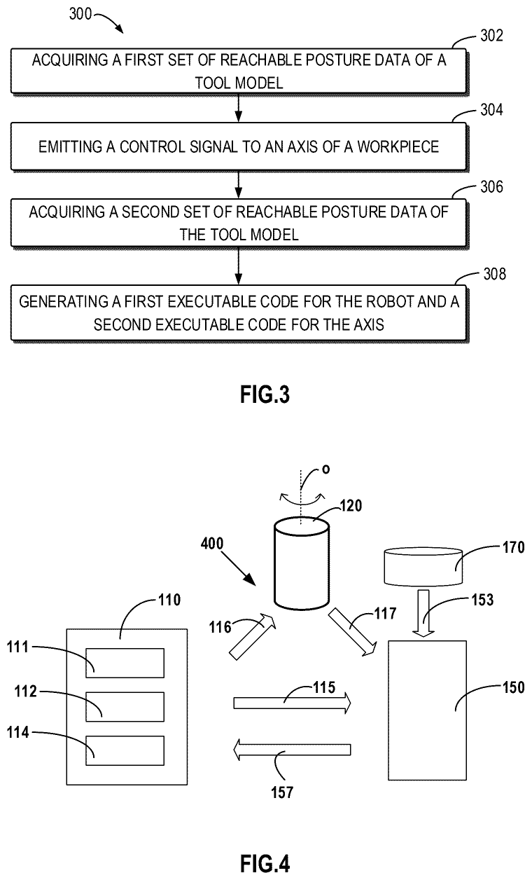

Hereinafter, in the case that the workpiece 120 to be processed (specifically, the axis O of the workpiece 120) is movable when teaching the robot by a PbD device or a tool model, the method for programming an industrial robot will be described with reference to FIG. 3 and FIG. 4.

FIG. 3 illustrates a flowchart of a method 300 for programming an industrial robot according to one example embodiment of the present disclosure. As shown in FIG. 3, the method 300 comprises the following actions. At block 302, posture data 115 of a tool model 110 is acquired by moved by a user around a first portion of the workpiece 120 to be processed in a reachable are of the robot. Whether the tool model is moving in the reachable area of the robot will be determined by the processor 150, which will be described in detail hereinafter. The tool model 110 is held by the user without being held by the robot 200.

At block 304, in response to that the first portion of the workpiece 120 has been processed by the tool model 110, a control signal 116 is emitted so as to move the workpiece 120 such that a second portion of the workpiece 120 is within the reachable area of the robot.

At block 306, a second set of reachable posture data 115 is acquired by moving the tool model around the second portion of the workpiece. In one example, the control single is aligned with an end point of the first set of reachable posture data and a start point of the second set of reachable posture data in time domain.

At block 308, at least based on the first set of reachable posture data, the control signal 116 and the second set of reachable posture data, a first executable code and a second executable code are generated, wherein the first executable code is to be executed by the robot to process the workpiece via a real tool 210 held by the robot 200, and the second executable is to be executed by the controller 150 to move the workpiece 120 when the workpiece 120 is processed by the real tool 210 f the robot

It should be understood that the first portion and the second portion are just illustrated for explaining the portion that may be reached by the robot and the portion that cannot be reached by the robot at a certain moment of the teaching process or at a certain posture of the workpiece. The first set of reachable posture data is used to illustrate the reachable posture data acquired before each movement of the workpiece 120, and the second set of reachable posture data is used to illustrate the reachable posture data acquired after each movement of the workpiece 120, and it does not mean that only two sets of reachable posture data are required during the whole teaching process. During the actual teaching process performed by the PbD device or the tool model 110, the workpiece 120 may be moved for two or more times, and thereby three or more portions of the workpiece 120 will be processed by the tool model 110 so as to acquire three or more sets of posture data.

In this method, the workpiece, in particularly, the axis O thereof, rotates or moves while demonstrating, data from the workpiece (specifically, from the axis O of the workpiece 120) and demonstration data are recorded and synchronized. The movement data of the workpiece 120 (specifically, the axis O of the workpiece 120) is recorded by an IPC and aligned with the PBD data in time domain. These data are then programmed into machine code sent to robot controller. The machine code or executable code (for example, the first executable code and the second executable code) from controller may be used to control robot 200 and the workpiece 120 (specifically, the axis O of the workpiece 120) simultaneously.

In this method, the workpiece 120 (specifically, the axis O of the workpiece 120) is controlled by the operator through the teaching device or tool model 110 in his/her hand while he/she is doing the demonstration, I/O control signals of the workpiece 120 (specifically, the axis O of the workpiece 120) and demonstration data are recorded and synchronized. After path planning and code generation, the robot 200 finally cooperates with the workpiece 120 (specifically, the axis O of the workpiece 120) to mimic what the operator did before, and the method for programing for the robot is of high efficiency, of high scalability and of easy operability. The programing for the robot may be operated by a skilled worker in the workshop, instead of a robot engineer or developer to program the robot in the field. Further, the workpieces may be of different shapes and through the demonstration of the PbD teaching device along with the movement of the workpiece 120 while teaching, a variety of workpieces may be processed by the robot. Thus, the usage of the teaching device and the robot may be expanded, and the automation level may be improved.

FIG. 4 is a block view of the system 400 for programming an industrial robot according to one example embodiment of the present disclosure. As shown in FIG. 4, the system 400 may comprise a tool model 110, a memory 170, and a processor 150 communicatively connected to the tool model 110 and the memory 170. The tool model 110 comprises a posture tracker 112 and an alarm device 114 configured to produce alarms. The posture tracker 112 may operate alone or in combination with other devices to track the posture of the tool model 110. The memory 170 may store structural characteristics 153 of the robot 200 in advance. In some embodiments, these structural characteristics 153 comprise D-H parameters of the robot 200. In other embodiments, the structural characteristics 153 comprise limit angles of joints of the robot 200. This is merely illustrative, and the memory 170 may comprise other parameters derived from the D-H parameters and the limit angles of the joints of the robot, and the like as long as these parameters can depict the reachability of the robot. The processor 150 is configured to obtain posture data 115 of the tool model 110 and to acquire structural characteristics 153 of the robot 200. The processor 150 is configured to determine reachability of the posture data 115 by the robot 200 based on the structural characteristics 153 of the robot 200. An alarm instruction 157 is sent in real time by the processor based on the determination result.

In some embodiments, as shown in FIG. 4, an alarm device 114, such as a lighting device, is provided on the tool model 110. The alarm device 114 is configured to produce warning in response to the alarm instructions from the processor. The alarms may be visible, audible, or tactile alarms, or of any other proper forms. In some embodiments, the strength, frequency of the alarm device or the like can change. For example, the lighting device can change color or/or blinking frequency to increase the warning degree for the user. Alternatively or in addition, in some embodiments, a display may be provided on the tool model and is configured to display text, graphic, and the like in response to the visible alarm instructions from the processor. Alternatively or in addition, a buzzer or a speaker may be provided to provide warnings to the user. In some embodiments, a tactile actuator may be provided to produce vibration feedback to the user. It is to be understood that the alarms may be various forms as long as the user may be warned in an efficient way. In the shown example, these warning devices are provided on the tool model. This is advantageous since the user is close to the tool model and can immediately know the movement conditions provided by the warning devices. It is to be understood that the warning devices may be provided at any other proper positions.

In some embodiments, as shown in FIG. 4, a signal trigger means 111 is provided on the tool model 110, the signal trigger means 111 may be triggered so as to emit a control signal 116 to control the movement of the workpiece 120, such that the already processed portion of the workpiece 120 is moved to the position where the portion to be processed of the workpiece 120 is located. After the movement, the user holding the tool model 110 may then process the new portion of the workpiece 120 that is in the reachable area of the robot 200. In some embodiments, the method 300 may further comprise sending an alarm according to the decision result of the posture data. In one embodiment, during movement of the tool model 110, a first alarm instruction 157 is sent in real time once it is determined that the posture data cannot be reached by the robot 200. In this way, according to the first alarm instruction, the user holding the tool model 110 can know that the current posture data cannot be reached. The posture should be adjusted by the user. This is particularly advantageous when the user is initially roughly moving the tool model around the workpiece before carefully moving the tool model. Through the rough movement of the tool model, the user can have a general profile of the safety area (i.e, the area that the robot 200 can surely reach).

In another embodiment, during movement of the tool, a second alarm instruction different from the first alarm instruction 157 in real time is sent once it is determined that a difference between the captured posture data 115 differs from posture data 115 that the robot 200 can reach by a predetermined threshold value. The predetermined threshold value may be determined in advance. By use of the predetermined threshold value, the user holding the tool model 110 can know that although the current posture data may be reached by the robot, it is close to a posture that cannot be reached by the robot. The user should change movement strategy in moving the robot to avoid having a posture that cannot be reached by the robot. This is particularly advantageous when the user is finely moving the tool model around the workpiece. Through the fine movement of the tool model, the program codes may be produced efficiently.

When finely moving the tool model 110 around a first portion of the workpiece 120, the alarm instruction may be demonstrated to the user holding the tool model 110 to illustrate that the current posture is going to be unreachable by the robot 200, and the user thus can change the posture of the tool model 110, for example, the spatial position thereof and orientation thereof.

After finely moving the tool model 110 around a first portion of the workpiece 120, the first portion of the workpiece 120 may be completely process by the tool model 110, and this may be determined by the user, for example, a skilled worker. At this time, the user holding the tool model 110 can trigger the signal trigger means 111 to send a control signal 116 for controlling the movement of the workpiece.

In one example, with the signal trigger means 111, the user can select the movement direction of the axis O of the workpiece 120 and send a fine control signal 116 for the axis O of the workpiece 120. By moving the axis O of the workpiece 120, a second portion may be reachable by the tool model 110. However, it should be understood that the signal trigger means 111 may be provided on the processor 150.

In some embodiment, the movement data 117 of the axis O may be fed back to the controller 150. When generating executable codes, the first set of reachable posture data, the movement data 117, and the second set of reachable posture data may be used to generating executable codes based on the first set of reachable posture data, the movement data, and the second set of reachable posture data.

In some embodiments, the method may further comprise coordinate system conversion. As shown in FIG. 1, the robot system 200 may comprise its own coordinate system X2, Y2, Z2 and the robot system 200 operates based on this coordinate system X2, Y2, Z2. On the other hand, the system 100 for programming the robot operates with its own coordinate system X1, Y1, Z1. The captured posture data thus is represented with coordinate system. In this event, in order to determine reachability of the posture data by the robot 200, the posture data should be converted to the robotic coordinate system. In some embodiments, a transfer matrix between a tool model coordinate system and a robot coordinate system is obtained. The posture data 115 from the tool model coordinate system may be converted to the robot coordinate system by the transfer matrix.

Hereinafter, some exemplary methods for determining whether the tool model is moving in the reachable area of the robot will be described.

In the first method, at first step, structural characteristics 153 of the robot 200, such as D-H parameters and limit angles of joints of the robot 200, is obtained. At second step, it is determined, based on the structural characteristics 153 of the robot 200 and the posture data 115 of the tool model 110, whether an angle of a joint of the robot 200 has a solution by using Inverse Kinematics. At third step, an alarm instruction 157 is sent in real time once it is determined that the angle of the joint of the robot 200 has no solution. Since the angle of the joint of the robot 200 has no solution, it means that the posture data shown by the tool model cannot be reached.

In some embodiments, when it is determined that the angle of the joint of the robot 200 has a solution, it is determined whether the solution is a singularity. Once it is determined that the solution is a singularity, an alarm instruction 157 is sent in real time. In this way, the singularity in the solution may be excluded.

In some embodiments, a boundary value that may be reached by the robot 200 may be determined based on D-H parameters of the robot 200 and/or limit angles of the joints. The boundary value may comprise a furthest distance that the robot 200 can reach, angle ranges that the joint of the robot 200 can achieve. An alarm instruction 157 may be sent to the alarming device based on a proximity degree of the posture data 115 to the boundary value. In some embodiments, the alarm signals may changes in terms of strength or frequency. In this way, the user can know in real time that the posture is close to the unreachable posture for the robot so that the user can trigger the signal trigger means 111 of the tool model 110 to emit a control signal 116 to the workpiece 120, such that the axis O of the workpiece 120 can rotate or translate.

In a second method, at the first step, D-H parameters of the robot 200 and limit angles of the joints of the robot 200 are acquired. At the second step, a workspace of the robot 200 that the robot 200 can reach is determined based on the acquired D-H parameters and the limit angles of the joints. The term “workspace” herein refers to an area that the robot 200 can surely reach. When the tool model is within this area, there is no risk to worry about the reachability of the robot. This workspace is determined in advance according to various factors, such as collision within the area, in addition to the structural characteristics of the robot. This workspace is typically smaller than the real area that the robot 200 is designed to reach. At third step, an alarm instruction 157 is sent once it is determined that the tool model 110 is close to, at, and/or out of a boundary of the workspace. With this method, by determining a reachable workspace in advance, an alarm is sent in accordance with proximity degree of the posture data 115 to a boundary of the predetermined workspace. In this way, the programming method can also be implemented with high efficacy.

In some embodiments, alarm instructions are changeable in terms of strength and/or frequency based on a proximity degree of the posture data 115 to a boundary of the workspace. For example, when the posture data 115 of the tool model is close to a boundary of the predetermined workspace by a predetermined threshold, an alarm instruction with a lower strength may be sent to the alarm device. The user can know that the user is getting close to risky area. When the posture data 115 of the tool model is further closer to the boundary of the predetermined workspace, the alarm instruction with increased strength may be sent to the alarm device. The user can know that the user is getting closer to risky area and should be careful with movement of the tool model. In some cases, the user should adjust its movement strategy, for example, move the tool model in an opposite direction that prevent the alarm device from alarming. In this way, the user can know that the current tool model is in the area that cannot be reached by the robot. When the posture data 115 of the tool model is at the boundary of the predetermined workspace, the alarm device operates at the maximum strength. On the other hand, when the user is back to the reachable area, the alarm device stops alarming. In this way, the user can know that the current tool model is back to the reachable area again.

In the shown example, the first portion of the workpiece 120 is designed to be processed, for example, along the path from P1 to P6 according to experience. The second portion of the workpiece 120 is designed to be processed, for example, along the path from P7 to P10 according to experience. As shown in FIG. 2, the path for processing a first portion of workpiece 120 is located in the reachable workspace 180 while the path for processing a second portion of the workpiece 120 is located outside the reachable workspace 180. During the programming process, the tool model should be moved within the reachable workspace 180. Once the tool model is close to or at the inner boundary 183 and the outer boundary 185 of the workspace 180, the user should be notified or warned, for example by the alarm device 114 provided on the tool model. On the other hand, when the user is back to the safety area or reachable area, the alarm device stops alarming. In this way, the user can know that the current tool model is back to the reachable area again. By operation of the alarm device 114, the user is prevented from moving the tool model on own will. In this way, the programming efficacy may be improved.

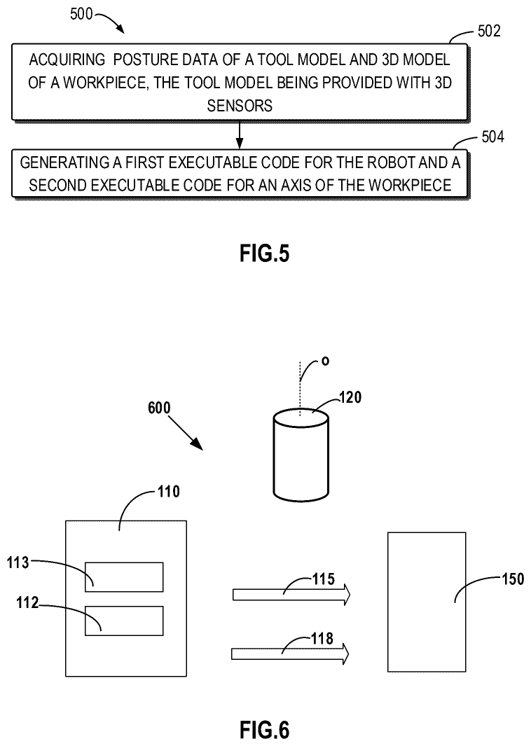

Hereinafter, in the case that an axis of a workpiece to be processed is movable when teaching the robot by a PbD device or a tool model, the method for programming an industrial robot will be described with reference to FIG. 5 and FIG. 6.

FIG. 5 illustrates a flowchart of a method 300 for programming an industrial robot according to one example embodiment of the present disclosure.

As shown in FIG. 5, the method 500 comprises the following actions. At block 502, a posture data 115 of a tool model and a three-dimensional model 118 of a workpiece to be processed are acquired simultaneously, by moving tool model provided with a three-dimensional sensor therein around the workpiece, wherein the tool model is held and moved by the user without being held by the robot, and the workpiece keeps stationary, and the three-dimensional sensor 113 are configured to acquire the three-dimensional model 118 of the workpiece.

At block 504, generating, at least based on the posture data and the three-dimensional model, a first executable code which is to be executed by the robot to process the workpiece via a real tool held by the robot, and a second executable code which is to be executed to move an axis of the workpiece.

FIG. 6 is a block view of the system 600 for programming an industrial robot according to the method as illustrated in FIG. 5. The components same to that shown in FIG. 4 will not be described again. Hereinafter, only the component different from that as shown in FIG. 4 will be described. As shown in FIG. 6, the tool model 110 is provided with three-dimensional (3D) sensors 113 configured to capture the three model 118 of the workpiece 120 to be processed or the object surrounding the workpiece 120. The 3D sensors 113 may be any of a binocular camera, a depth-sensing camera, laser radar, and other sensors that may be used to sense 3D model of the object. The 3D sensors 113 and the tool model 110 are calibrated in advance, such that when the posture data 115 of the tool model 110 is obtained, the 3D model 118 of the workpiece 120 is obtained accordingly.

In the conventional design, information processing center (IPC) or the processor is used to generate code for robot as well as an external axis O of the workpiece 120. The 3D model of the workpiece and the 3D model of surrounding object should be input to the IPC. However, aligning the path obtained by the PbD device to 3D model needs lots of manual efforts. Furthermore, some of the objects only have 2D pictures, and there is no existing 3D model for these object or workpiece.

In this method, the axis O of the workpiece 120 cannot be moved when teaching the robot 200 by PbD device or tool model 110. The tool model 110 is provided with three-dimensional (3D) sensors therein, and the sensors are configured to capture a 3D model of the workpiece 120 when moving the tool model 110 around the workpiece 120. Thus, the posture data 150 (or a trajectory) and the scanning data (3D model) are recorded synchronously, and they are aligned with each other in spatial domain. The path and 3D model are naturally aligned, wherein the 3D sensor 113 in the tool model 110 and teaching device calibrated in advance. Therefore, no CAD model is needed anymore for automatic motion plan and code generation while teaching with the PbD. Further, there is no need for any effort to align the path and the 3D model, thereby causing the process high efficiency and time-saving.

The process for acquiring the posture data of the tool model 110 is the same to that for acquiring the posture data 115 as shown in FIG. 4, and thus the process will not be described again. Further, in this method, there is no need to determine the reachability of the posture data 115 when moving the tool model 110 around the workpiece 120, and thus there is no need to provide the signal trigger means 111 in the tool model 110, and there is also no need to transmit alarm instruction 157 to the tool model 110 from the controller 150.

In this method, the acquired posture data 115 are processed by IPC. The external axis stands still while demonstrating, the demonstrated path will be segmented due to robot workspace and the movement of external axis is generated based on the segmentation results. Finally, the new paths (after segmentation) and movement of externa axis are programmed to machine code automatically. The movement of external axis is generated based on the intrinsic and extrinsic properties of external axis. The intrinsic property is the relationship between the input signal (for example, the information about movement indicated by the signal received from the controller) and the output movement (for example, the real moving angle or distance of the axis). The extrinsic property is the geometry/structure relationship between the axis O and robot 200.

Specifically, the posture data are segmented into a plurality of segments, based on a robot workspace of the robot 200 and a position relationship between the robot 200 and the workpiece 120. With respect to each segment, the IPC can generate a reachable working path and a movement of the axis O of the workpiece 120. At a certain posture of the axis O, there are reachable path and unreachable path. If the segment is out of reach of the robot 200, the IPC will generate information indicating the movement of the workpiece 120 (specifically, the axis O), and with respect to this new posture of the axis O of the workpiece 120, a new path will generated to replace the segment out of reach of the robot 200. Then, the new reachable path will be programmed to the first executable code for the robot 200, and the information about the movement of the workpiece 120 (specifically, the axis O) will be programmed to the second executable code for the axis of the workpiece 120.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3, 5, and 6. Generally, program modules include routines, programs, libraries, objects, classes, components, data structures, or the like that perform particular tasks or implement particular abstract data types. The functionality of the program modules may be combined or split between program modules as desired in various embodiments.

Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. On the other hand, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for programing an industrial robot, comprising:
acquiring a first set of reachable posture data of a tool model by moving the tool model around a first portion of a workpiece in a reachable area of the robot, the tool model being held and moved by a user without being held by the robot;
in response to that the first portion of the workpiece has been processed by the tool model, causing the tool model to emit a control signal to move the workpiece such that a second portion of the workpiece is within the reachable area of the robot;
acquiring a second set of reachable posture data of the tool model by moving the tool model around the second portion of the workpiece; and
generating, at least based on the first set of reachable posture data, the control signal and the second set of reachable posture data, a first executable code which is to be executed by the robot to process the workpiece via a real tool held by the robot, and a second executable code which is to be executed to move the workpiece when the robot processes the workpiece via the real tool.

2. The method of claim 1, wherein acquiring each of the first and second sets of the reachable posture data of the tool model comprises:
receiving posture data of the tool model from a posture tracker configured to capture the posture data;
acquiring a transfer matrix between a tool model coordinate system and a robot coordinate system;
converting the posture data from the tool model coordinate system to the robot coordinate system by the transfer matrix;
determining reachability of the posture data by the robot; and
acquiring the reachable posture data based on the reachability of the posture data.

3. The method of claim 1, further comprising:
acquiring a movement data of the workpiece associated with the control signal,
wherein generating the first executable code and the second executable code comprises:
based on the first set of reachable posture data, the movement data, and the second set of reachable posture data, generating the first executable code and the second executable code.

4. The method of claim 1, wherein the control signal is aligned with an end point of the first set of reachable posture data and a start point of the second set of reachable posture data in time domain.

5. The method of claim 1, wherein the posture data comprises spatial position data and orientation data about each point on a moving path of the tool model; and
the movement of the workpiece comprises at least one of a translation of the workpiece and a rotation of the workpiece around an axis.

6. The method of claim 1, further comprising:
during movement of the tool model, sending an alarm instruction in real time once it is determined that the posture data is approaching boundary of the reachable area of the robot.

7. A method for programing an industrial robot, comprising:
acquiring a posture data of a tool model and a three-dimensional model of a workpiece to be processed simultaneously, by moving tool model provided with at least one three-dimensional sensor therein around the workpiece, wherein the tool model is held and moved by a user without being held by the robot, and the workpiece keeps stationary, and the at least one three-dimensional sensor is configured to acquire the three-dimensional model of the workpiece; and
generating, at least based on the posture data and the three-dimensional model, a first executable code which is to be executed by the robot to process the workpiece via a real tool held by the robot, and a second executable code which is to be executed to move the workpiece.

8. The method of claim 7, wherein generating the first executable code and the second executable code comprises:
segmenting the posture data into a plurality of segments, based on a robot workspace of the robot and a position relationship between the robot and the workpiece;
generating a working path and a movement of the workpiece for each of the plurality of segments; and
programing the first executable code based on the working path for each of the plurality of segments and the second executable code based on the movement of the workpiece for each of the plurality of segments.

9. The method of claim 7, wherein acquiring the posture data of the tool model comprises:
receiving the posture data of the tool model from a posture tracker configured to capture the posture data;
acquiring a transfer matrix between a tool model coordinate system and a robot coordinate system; and
converting the posture data from the tool model coordinate system to the robot coordinate system by the transfer matrix.

10. The method of claim 7, wherein the at least one three-dimensional sensor is calibrated with respect to the tool model; and
the posture data of the tool model and the three-dimensional model of the workpiece are aligned with each other in spatial domain.

11. A system for programming an industrial robot, comprising:
a tool model configured to move around a workpiece to be processed;
a posture tracker configured to capture posture data of a tool model moved by a user around the workpiece; and
a processor configured to:
acquire a first set of reachable posture data of a tool model by moving the tool model around a first portion of a workpiece in a reachable area of the robot, the tool model being held and moved by a user without being held by the robot;
in response to that the first portion of the workpiece has been processed by the tool model, cause the tool model to emit a control signal to move the workpiece such that a second portion of the workpiece is within the reachable area of the robot;
acquire a second set of reachable posture data of the tool model by moving the tool model around the second portion of the workpiece; and
generate, at least based on the first set of reachable posture data, the control signal and the second set of reachable posture data, a first executable code which is to be executed by the robot to process the workpiece via a real tool held by the robot, and a second executable code which is to be executed to move the workpiece when the robot processes the workpiece via the real tool.

12. A system for programming an industrial robot, comprising:
a tool model configured to move around a workpiece to be processed;
a posture tracker configured to capture posture data of a tool model moved by a user around the workpiece; and
a processor configured to:
acquire a posture data of a tool model and a three-dimensional model of a workpiece to be processed simultaneously, by moving tool model provided with at least one three-dimensional sensor therein around the workpiece, wherein the tool model is held and moved by a user without being held by the robot, and the workpiece keeps stationary, and the at least one three-dimensional sensor is configured to acquire the three-dimensional model of the workpiece; and
generating, at least based on the posture data and the three-dimensional model, a first executable code which is to be executed by the robot to process the workpiece via a real tool held by the robot, and a second executable code which is to be executed to move the workpiece.

13. A computer program product being tangibly stored on a computer readable storage medium and comprising instructions which, when executed on at least one processor, cause the at least one processor to perform the method according to claim 1.

14. A computer program product being tangibly stored on a computer readable storage medium and comprising instructions which, when executed on at least one processor, cause the at least one processor to perform the method according to claim 7.

15. The method of claim 2, wherein the control signal is aligned with an end point of the first set of reachable posture data and a start point of the second set of reachable posture data in time domain.

16. The method of claim 3, wherein the control signal is aligned with an end point of the first set of reachable posture data and a start point of the second set of reachable posture data in time domain.
